(19) United States
(12) Patent Application Publication
(10) Pub. No.: US 2020/0356528 A1
(43) Pub. Date: Nov. 12, 2020

(54) SYSTEM AND METHOD FOR ARCHIVE FILE CHECK-IN/OUT IN AN ENTERPRISE CONTENT MANAGEMENT SYSTEM

(71) Applicant: ORACLE INTERNATIONAL CORPORATION, Redwood Shores, CA (US)

(72) Inventors: Shyam Babu Prasad, Bangalore (IN); Bhageerath Arasachetty, Bangalore (IN); Praveen Kumar Jayaram, Bangalore (IN)

(21) Appl. No.: 16/409,247

(22) Filed: May 10, 2019

(51) Int. Cl. G06F 16/14; G06F 16/176; G06F 16/11; G06F 16/16; H04L 29/08

(52) U.S. Cl. CPC G06F 16/156; G06F 16/176; H04L 67/06; G06F 16/168; G06F 16/113

(57) ABSTRACT

Described herein are systems and methods archive file check-in/out in an enterprise content management system. The systems and methods described can allow user of ECM systems to check-in an archive file and, upon check-in, have the ECM application automatically explode the content(s) of the archive file to represent the contents in a hierarchical structure with folder(s) and file(s). As well, in legacy ECM systems, the systems and methods can explode already uploaded archive files to represent them in a hierarchical structure with folder(s) and file(s) within the application itself. In addition, the systems and methods can provide for checkout of an archive file from an ECM system. Upon checkout, the ECM system can extract the content item(s) inside a pre-selected destination directory on a client machine.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF INVENTION

Embodiments of the invention are generally related to archive file check-in/out, and are particularly related to a system and method for enabling archive file check-in/out in a content management system, such as an Enterprise Content Management (ECM) system.

### BACKGROUND

Content management systems enable content to be created, uploaded, accessed, and modified by a plurality of users. For example, a content item such as a document can be created and uploaded by one user, and subsequently accessed and modified by other users. Additionally, a single document can be accessed (e.g., viewed) concurrently by multiple users. Content management systems can be useful for enterprises in which, for example, several individuals collaborate on a project by accessing the same document or set of documents.

Complexities can arise, however, when a user wishes to upload multiple content items. In such situations, the user can generally presented with an option to create an archive file (e.g., zip file, or other archive file type that merges/compresses multiple content files into a single file) so that all the files to be uploaded to an ECM application and perform a single check-in operation in order avoid multiple check-in operations that would be required if each content item was uploaded individually. However, the uploaded archive file not exploded (e.g., de-compressed, extracted . . . etc.) by an ECM application into an easy to use hierarchy, nor are the content items represented outside of the archive file.

### SUMMARY

Described herein are systems and methods for archive file check-in/out in an enterprise content management system. A method for performing automatic archive file explosion during check-in operation at an ECM system can provide an application server comprising an enterprise content management system. The method can provide a plurality of databases associated with the application server. The method can provide a user interface accessible by one or more users, wherein the user interface is configured to receive instructions to upload an archive file to the enterprise content management system, wherein the archive file comprises a plurality of content items and a plurality of metadata. Upon upload of the archive file, the method can automatically explode the archive file into the plurality of content items and the plurality of associated metadata. The method can store the plurality of content items at a first database of the plurality of databases. The method can store the plurality of metadata at a second database of the plurality of databases.

In accordance with an embodiment, a method for performing automatic archive file explosion during an archive access operation at an ECM system can be provided. The method can provide an application server comprising an enterprise content management system. The method can provide a plurality of databases associated with the application server. The method can provide a user interface accessible by one or more users, wherein the user interface is configured to receive instructions to retrieve an archive file stored at a first database of the plurality of databases, wherein the archive file comprises a plurality of content items and a plurality of metadata. Upon retrieval of the archive file, the method can automatically explode the archive file into the plurality of content items and the plurality of associated metadata. The method can store the plurality of content items at the first database of the plurality of databases. The method can store the plurality of metadata at a second database of the plurality of databases.

In accordance with an embodiment, a method for performing automatic archive file explosion during a check-out operation at an ECM system can be provided. The method can provide an application server comprising an enterprise content management system. The method can provide a plurality of databases associated with the application server. The method can provide a user interface accessible by one or more users, wherein the user interface is configured to receive instructions to check-out an archive file stored at a first database of the plurality of databases, wherein the archive file comprises a plurality of content items and a plurality of metadata. The method can retrieve the archive file from the first database. Upon retrieval of the archive file, the method can automatically explode the archive file into the plurality of content items and the plurality of associated metadata. The method can check-out the plurality of content to a user device together with the plurality of metadata.

### BRIEF DESCRIPTION OF THE FIGURES

FIG. 1 illustrates a system or archive file check-in/out in an enterprise content management system, in accordance with an embodiment.

FIG. 2 illustrates a system or archive file check-in/out in an enterprise content management system, in accordance with an embodiment.

FIG. 3 shows an archive file (e.g., zip file) explosion during check-in in an ECM system, in accordance with an embodiment.

FIG. 4 is a flow chart of a method for performing automatic archive file explosion during check-in operation at an ECM system.

FIG. 5 shows an archive file (e.g., zip file) explosion within an ECM system, in accordance with an embodiment.

FIG. 6 is a flow chart of a method for performing automatic archive file explosion during an archive access operation at an ECM system.

FIG. 7 shows an archive file (e.g., zip file) explosion during checkout of an ECM system, in accordance with an embodiment.

FIG. 8 is a flow chart of a method for performing automatic archive file explosion during a check-out operation at an ECM system.

### DETAILED DESCRIPTION

The foregoing, together with other features, will become apparent upon referring to the enclosed specification, claims, and drawings. Specific details are set forth in order to provide an understanding of various embodiments. However, it will be apparent that various embodiments may be practiced without these specific details. The enclosed specification and drawings are not intended to be restrictive.

As described above, content management systems enable content to be created, uploaded, accessed, and modified by a plurality of users. For example, a content item such as a document can be created and uploaded by one user, and subsequently accessed and modified by other users. Additionally, a single document can be accessed (e.g., viewed) concurrently by multiple users. Content management systems can be useful for enterprises in which, for example, several individuals collaborate on a project by accessing the same document or set of documents.

Complexities can arise, however, when a user wishes to upload multiple content items. In such situations, the user can generally be presented with an option to create an archive file (e.g., zip file, or other archive file type that merges/compresses multiple content files into a single file) so that all the files to be uploaded to an ECM application and perform a single check-in operation in order avoid multiple check-in operations that would be required if each content item was uploaded individually. However, the uploaded archive file not exploded by an ECM application into an easy to use hierarchy, nor are the content items represented outside of the archive file.

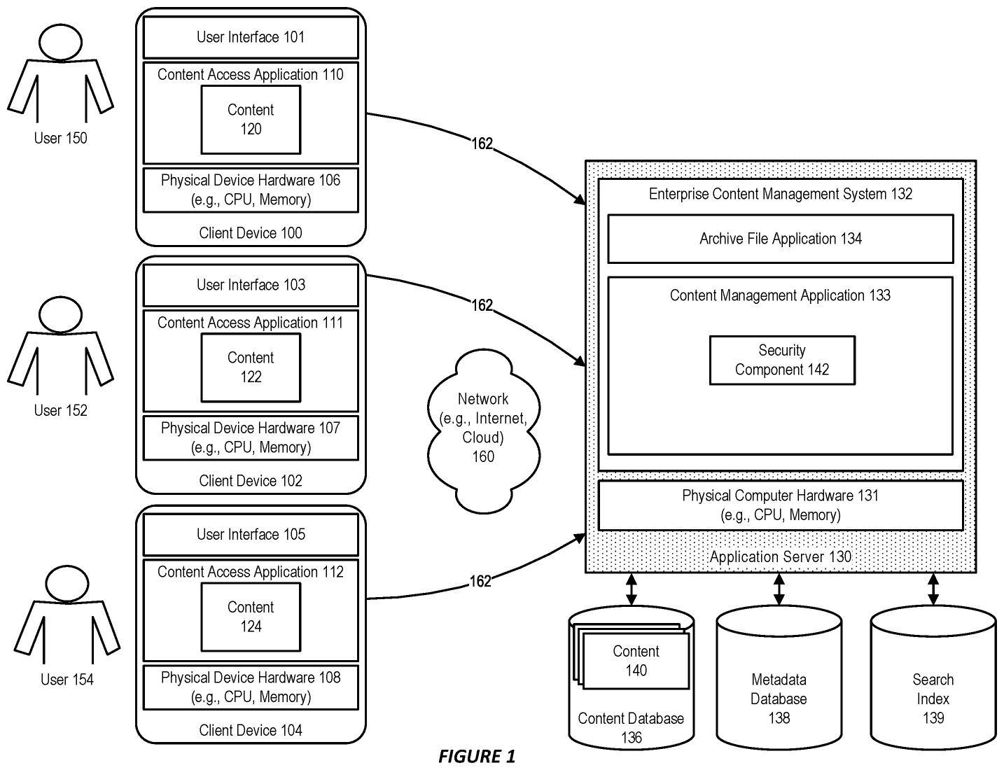

FIG. 1 illustrates a system or archive file check-in/out in an enterprise content management system, in accordance with an embodiment

As illustrated in FIG. 1, in accordance with an embodiment, for each of a plurality of client devices 100, 102, and 104 having a user interface 101, 103, 105 and physical device hardware 106, 107, 108 (e.g., CPU, memory), the client device can be provided with a content access application 110, 111, 112 for execution thereon.

In accordance with an embodiment, the client device can communicate 162 with an application server 130 that includes a physical computer hardware 131 (e.g. CPU, memory) and an enterprise content management system 132.

In accordance with an embodiment, the content access application at the client device can communicate with the enterprise content management system via a network 160 (e.g., the Internet, or a cloud environment). The content access application can be configured to enable a user 150, 152, 154 to view, upload, modify, delete, or otherwise access content such as content items 120, 122, 124 at each client device. For example, new content can be added or uploaded to the enterprise content management system by a user interacting with the content access application on an associated client device. The content can be transmitted to the enterprise content management system for storage.

In accordance with an embodiment, the enterprise content management system can be or include a platform for consolidating content that can be managed by a plurality of users of an enterprise. In accordance with an embodiment, the enterprise content management system can be configured to communicate with a content database 136 for storing content (or content items) 140, and can deliver the content to users via their client devices. In accordance with an embodiment, the content database can be a relational database management system (RDBMS), file system, or other data source which the enterprise content management system can access. Content can include, for example, documents, files, e-mails, memos, images, videos, slide presentations, conversations, and user profiles.

In accordance with an embodiment, the enterprise content management system can be configured to associate metadata with the content. Metadata can include information about an item of content, such as its title, author, release date, historical data such as who has accessed the item and when, a location where the content is stored, and the like.

In accordance with an embodiment, the metadata can be stored in a metadata database 138. In accordance with an embodiment, the enterprise content management system can be configured to communicate with the metadata database to access metadata stored therein, and to store metadata generated by the system in the metadata database.

In accordance with an embodiment, the enterprise content management system can also be configured to communicate with a search index 139. The search index can be configured to provide indexing and searching of content and data stored in the content database and the metadata database. In accordance with an embodiment, the search index can be a relational database management system (RDBMS) or a search tool such as Oracle Secure Enterprise Search (Oracle SES).

In accordance with an embodiment, content stored within the content database can be checked out for modification by a user at the user's client device, and checked back in to the enterprise content management system.

In accordance with an embodiment, a checked out document can be locked while checked out to a particular user, to prevent other users from modifying the checked out document. However, the system can be configured to permit viewing of the document by other users while it is checked out. In accordance with an embodiment, new versions of content can be created and stored in the content database of the enterprise content management system.

In accordance with an embodiment, the archive file application 134 can be provided at the ECM system 132 in order to allow users 150, 152, 154 to check in/out archive files in one step. The check in/out activities can comprise automatically expanding/exploding (throughout this specification, the term “explode” can be used to mean a variety of actions depending upon the type of archive file. Similar and analogous terms can be used in place of the term, including, for example, decompress, extract, unzip . . . etc.) archive files upon check in/out.

In accordance with an embodiment, the archive file check-in/out module can be provided as an independent pluggable module for use with one or more existing content management systems, including the enterprise content management system 132.

In accordance with an embodiment, the enterprise content management system can further include a content management application 133 including a security component 142. The security component can include or store a security data including user permissions and privileges with respect to particular items of content and/or particular actions. For example, the security data can indicate that certain users are permitted to access and/or modify certain documents. As another example, the security data can indicate that only certain users are permitted to create links between content items, to modify certain content items, or to delete content items.

In accordance with an embodiment, the archive file check-in/out module can provide users of an enterprise content management system, including legacy ECM applications, the power to explode the content(s) of an archive (e.g., zip) file that is already uploaded and also upon new check-in and checkout operations in an ECM application to represent the contents of the archive file in a hierarchical structure.

In accordance with an embodiment, users of the ECM system, in general, make use of archive functionality when it is desired to upload multiple files into ECM system with single request. However, the user's expectation will be to represent the content(s) of the archive file within an ECM application as if the archive file is exploded and represented in hierarchical structure with folder(s) and file(s).

In accordance with an embodiment, the systems and methods provided herein can enable users of ECM systems, including legacy systems, to explode already uploaded archive files to represent them in a hierarchical structure with folder(s) and file(s). The systems and methods can also provide the operability to upload archive files and have the ECM system automatically explode the contents of the archive file and represent them in hierarchical structure with folder(s) and file(s). Similarly, the systems and methods herein can enable the users of the ECM system to select and download/checkout an archive file, and have the archive file automatically exploded as if the file was exploded post download on the client machine manually.

In accordance with an embodiment, when a user selects multiple files and performs a check-in operation, the systems and methods can archive the selected content(s), and extract the files automatically to represent them in the ECM application as if the files were checked into ECM application individually. Similarly, when a user selects an archive file and performs a checkout operation, the systems and methods can extract the content(s) of the archive file on the server-side and push each file one-by-one as if each files were checked-out individually.

In accordance with an embodiment, ECM systems comprise of a repository to store contents and allow access to these stored content items as and when required. Users frequently perform operations such as check-in and checkout operation. The access permissions on content items can vary from Read, Write, Delete and Admin depending upon user privileges

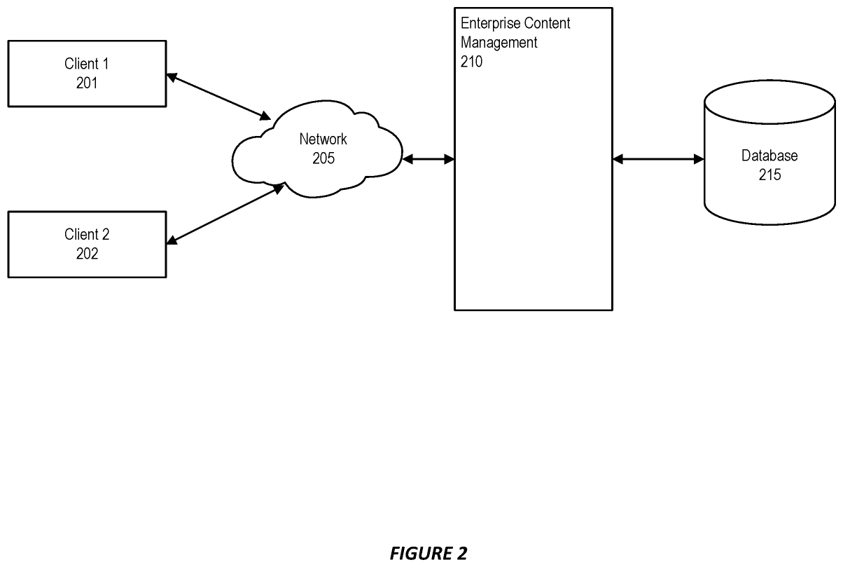

FIG. 2 illustrates a system or archive file check-in/out in an enterprise content management system, in accordance with an embodiment.

In accordance with an embodiment, in general, Enterprise Content Management 210 systems consists of a repository to store contents (e.g., database 215) and allow access to these stored content items as and when required via the ECM. Frequently performed operations by users 201, 202 of the ECM system can comprise check-in and checkout operations. The access permissions on content items can vary from Read, Write, Delete and Admin depending upon User privileges.

In accordance with an embodiment, the systems and methods described herein can allow users/clients 201, 202, who access the ECM system via, e.g., a network 205, of ECM 210 systems to check-in an archive file and, upon check-in, have the ECM application automatically explode the content(s) of the archive file to represent the contents in a hierarchical structure with folder(s) and file(s). As well, in legacy ECM systems, the systems and methods can explode already uploaded archive files to represent them in a hierarchical structure with folder(s) and file(s) within the application itself. In addition, the systems and methods can provide for checkout of an archive file from an ECM system. Upon checkout, the ECM system can extract the content item(s) inside a pre-selected destination directory on a client machine.

Archive File Explosion within and During Check-in in ECM

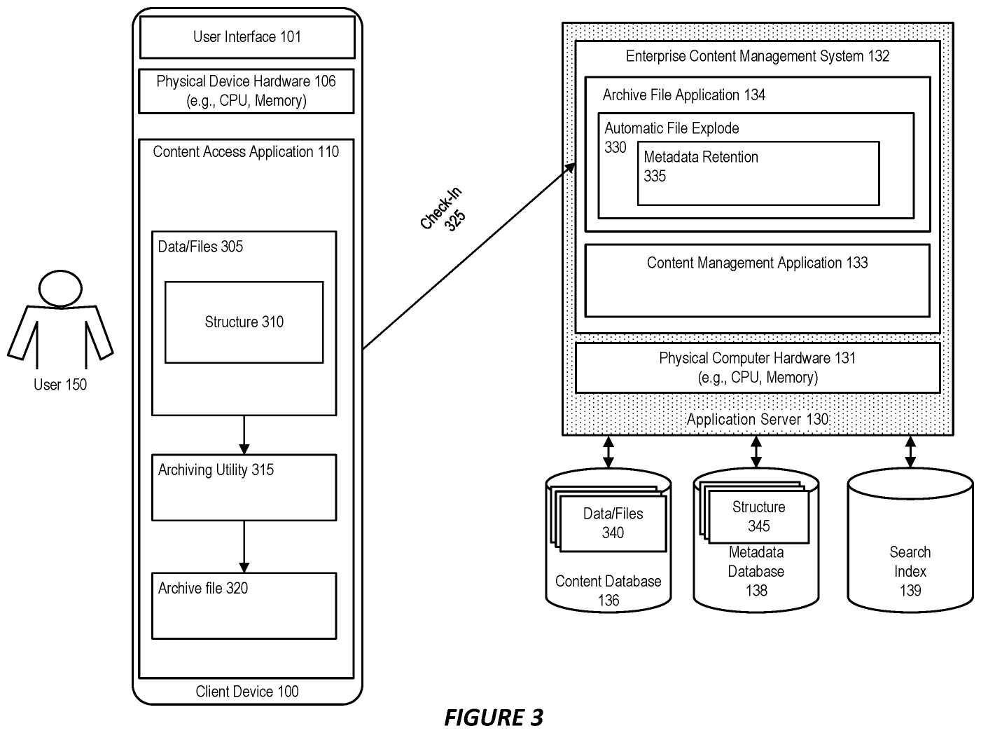

FIG. 3 shows an archive file (e.g., zip file) explosion during check-in in an ECM system, in accordance with an embodiment.

In accordance with an embodiment a typical enterprise content management system, frequently performed operations are check-in and checkout operations. In general, when a user wants to upload multiple content items, the user will have an option to archive all the files to be uploaded to an ECM system and perform check-in operation to avoid multiple check-in operations.

In accordance with an embodiment, when a user wants to represent each of the content items in the uploaded archive file independently in an ECM system, the user needs to perform multiple check-in operations. Moreover, when the hierarchical structure of the archive file wants to be replicated in an ECM application, a user needs to perform additional operation to create folder(s) and navigate inside each of the created folder to upload respective content items per folder, while preserving the hierarchical structure.

In accordance with an embodiment, the systems and methods provided herein enable users of ECM systems to upload multiple content items and/or archive files into an ECM system by performing single check-in operation and still represent the content items in a hierarchical structure as if the content items were uploaded independently. When a user uploads an archive file by performing a check-in operation and flags it as archive explode check-in operation, the ECM system can first copy the archive file at a temporary location on the server-side and explode it. Then, the internal check-in agent can automatically, based upon the received flag, start a check-in process for each content item within the archive file one-by-one, while maintaining the original structure (e.g., hierarchical structured) of the files.

As illustrated in FIG. 3, in accordance with an embodiment, for a client device 100, having a user interface 101, and physical device hardware 106, (e.g., CPU, memory), the client device can be provided with a content access application 110 for execution thereon.

In accordance with an embodiment, the client device can be in communication with an application server 130 that includes a physical computer hardware 131 (e.g. CPU, memory) and an enterprise content management system 132, which can include a content management application 133 and an archive file application 134.

In accordance with an embodiment, the content access application at the client device can communicate with the enterprise content management system via a network. The content access application can be configured to enable a user 150 to view, upload, modify, delete, or otherwise access content such as data/files client device. For example, new content can be added or uploaded to the enterprise content management system by a user interacting with the content access application on an associated client device. The content can be transmitted to the enterprise content management system for storage.

In accordance with an embodiment, the enterprise content management system can be or can include a platform for consolidating content that can be managed by a plurality of users of an enterprise. In accordance with an embodiment, the enterprise content management system can be configured to communicate with a content database 136 for storing content (or content items), and can deliver the content to users via their client devices. In accordance with an embodiment, the content database can be a relational database management system (RDBMS), file system, or other data source which the enterprise content management system can access. Content can include, for example, documents, files, e-mails, memos, images, videos, slide presentations, conversations, and user profiles.

In accordance with an embodiment, the enterprise content management system can be configured to associate metadata with the content. Metadata can include information about an item of content, such as its title, author, release date, historical data such as who has accessed the item and when, a location where the content is stored, hierarchical structure of data, and the like.

In accordance with an embodiment, the metadata can be stored in a metadata database 138. In accordance with an embodiment, the enterprise content management system can be configured to communicate with the metadata database to access metadata stored therein, and to store metadata generated by the system in the metadata database.

In accordance with an embodiment, the enterprise content management system can also be configured to communicate with a search index 139. The search index can be configured to provide indexing and searching of content and data stored in the content database and the metadata database. In accordance with an embodiment, the search index can be a relational database management system (RDBMS) or a search tool such as Oracle Secure Enterprise Search (Oracle SES).

In accordance with an embodiment, the content access application 110 can comprise an archiving utility 315, and can have access to data/files 305, which can comprise a structure 310. The archiving utility can be used to create/update an archive file 320 based upon the data/files 305, along with the related structure 310.

In accordance with an embodiment, the archive file application 134 can be provided at the ECM system 132 in order to allow users 150 to check in/out archive files (e.g., archive file 320) in one step. The check in/out activities can comprise automatically expanding/exploding (throughout this specification, the term “explode” can be used to mean a variety of actions depending upon the type of archive file. Similar and analogous terms can be used in place of the term, including, for example, decompress, extract, unzip . . . etc.) archive files upon check in/out.

In accordance with an embodiment, the archive file check-in/out module can be provided as an independent pluggable module for use with one or more existing content management systems, including the enterprise content management system 132.

In accordance with an embodiment, upon receiving an archive file 320 via a check-in operation 325, the archive file application 134 can invoke the automatic file explode process 330 on the checked-in archive file 320. This automatic file explode process 330 can comprise a metadata retention process 335.

In accordance with an embodiment, upon the check-in of the archive file 320, the archive file application 134 copy the archive file 320 at a temporary location on the server-side (not shown) and explode it. Then, the a check-in agent of the content management application 133 can automatically, based upon the received flag, start a check-in process for each content item and data/files 340 within the archive file one-by-one, while maintaining the original structure (e.g., hierarchical structured) of the files based upon structure data 345 stored. The check-in agent can then store the exploded data/files 340 at the content database 136, and can store the associated structure data 345 at the metadata database.

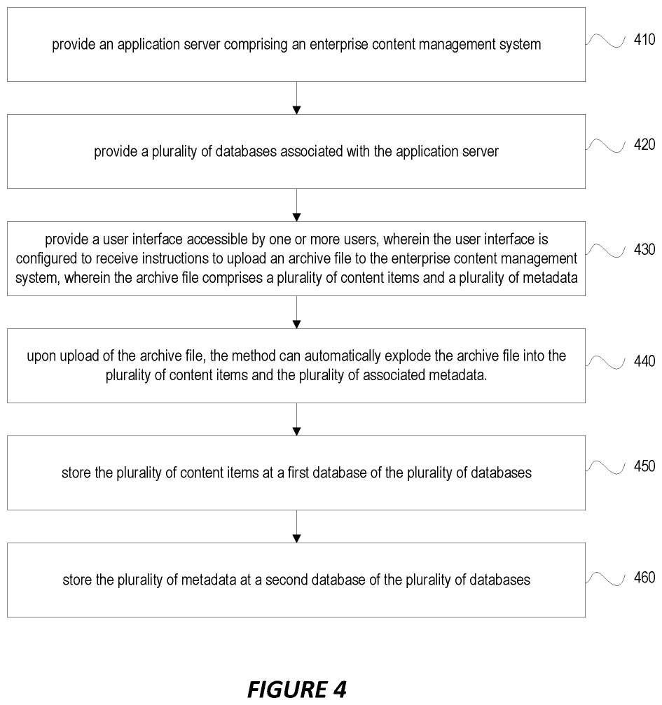

FIG. 4 is a flow chart of a method for performing automatic archive file explosion during check-in operation at an ECM system.

At step 410, the method can provide an application server comprising an enterprise content management system.

At step 420, the method can provide a plurality of databases associated with the application server.

At step 430, the method can provide a user interface accessible by one or more users, wherein the user interface is configured to receive instructions to upload an archive file to the enterprise content management system, wherein the archive file comprises a plurality of content items and a plurality of metadata.

At step 440, upon upload of the archive file, the method can automatically explode the archive file into the plurality of content items and the plurality of associated metadata.

At step 450, the method can store the plurality of content items at a first database of the plurality of databases.

At step 460, the method can store the plurality of metadata at a second database of the plurality of databases.

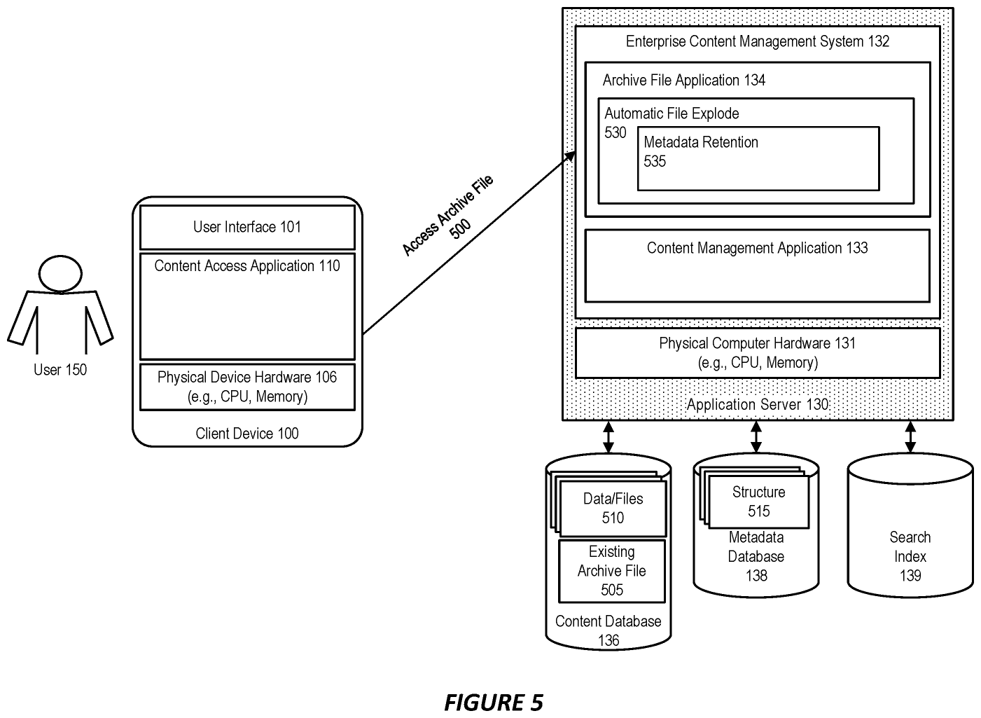

FIG. 5 shows an archive file (e.g., zip file) explosion within an ECM system, in accordance with an embodiment.

In a legacy enterprise content management systems, users of ECM systems were driven towards packaging multiple content items into a single archive file, and uploading the archive file to an ECM system. This limited the users from accessing the content items within the uploaded archive file. As well, users in the future would be forced to download the archive file and explode it every time the user wanted to access any content item within the archive file, again a time consuming task.

In accordance with an embodiment, the systems and methods described herein address this concern in legacy ECM systems by providing automatic exploding of already uploaded archive files to represent them in a hierarchical structure with folder(s) and file(s) within the ECM system. This enables users to access the content items of the archive file without the need to download and explode. Moreover, users are allowed to act on each of the content items in a more appropriate way and perform content management functionalities independently on each of the content item.

In accordance with an embodiment, in legacy enterprise content management system, many users have packaged multiple content items into a single archive file and uploaded it to an ECM system to avoid multiple check-in operations (also due to time constraints). To support such legacy ECM applications, the systems and methods provided herein can also provide features to explode the already uploaded archive file into a hierarchical representation of folder(s) and file(s) corresponding to that particular archive file, while preserving the hierarchical structure.

In accordance with an embodiment, the systems and methods provided herein enable users of ECM systems to explode existing archive files in ECM systems without downloading the archive file first, then uploading each content item individually. When a user accesses 500 an existing archive file 505, the ECM system can first copy the existing archive file at a temporary location on the server-side and explode it. Then, the internal check-in agent can automatically, based upon the received flag, start a check-in process for each content item within the archive file one-by-one, while maintaining the original structure (e.g., hierarchical structured) of the files.

As illustrated in FIG. 5, in accordance with an embodiment, for a client device 100, having a user interface 101, and physical device hardware 106, (e.g., CPU, memory), the client device can be provided with a content access application 110 for execution thereon.

In accordance with an embodiment, the client device can be in communication with an application server 130 that includes a physical computer hardware 131 (e.g. CPU, memory) and an enterprise content management system 132, which can include a content management application 133 and an archive file application 134.

In accordance with an embodiment, the content access application at the client device can communicate with the enterprise content management system via a network. The content access application can be configured to enable a user 150 to view, upload, modify, delete, or otherwise access content such as data/files client device. For example, existing content, such as existing archive file 505, can be viewed, modified, deleted, amended . . . etc. by a user interacting with the content access application on an associated client device.

In accordance with an embodiment, the enterprise content management system can be or can include a platform for consolidating content that can be managed by a plurality of users of an enterprise. In accordance with an embodiment, the enterprise content management system can be configured to communicate with a content database 136 for storing content (or content items), and can deliver the content to users via their client devices. In accordance with an embodiment, the content database can be a relational database management system (RDBMS), file system, or other data source which the enterprise content management system can access. Content can include, for example, documents, files, e-mails, memos, images, videos, slide presentations, conversations, and user profiles.

In accordance with an embodiment, the enterprise content management system can be configured to associate metadata with the content. Metadata can include information about an item of content, such as its title, author, release date, historical data such as who has accessed the item and when, a location where the content is stored, hierarchical structure of data, and the like.

In accordance with an embodiment, the metadata can be stored in a metadata database 138. In accordance with an embodiment, the enterprise content management system can be configured to communicate with the metadata database to access metadata stored therein, and to store metadata generated by the system in the metadata database.

In accordance with an embodiment, the enterprise content management system can also be configured to communicate with a search index 139. The search index can be configured to provide indexing and searching of content and data stored in the content database and the metadata database. In accordance with an embodiment, the search index can be a relational database management system (RDBMS) or a search tool such as Oracle Secure Enterprise Search (Oracle SES).

In accordance with an embodiment, the archive file application 134 can be provided at the ECM system 132 in order to allow users 150 to have existing archive files 505 be automatically exploded, via an automatic file explode process 530, upon request.

In accordance with an embodiment, the archive file check-in/out module can be provided as an independent pluggable module for use with one or more existing content management systems, including the enterprise content management system 132.

In accordance with an embodiment, upon receiving an access archive file request 500, the archive file check-in/check-out module can access an existing archive file 505 at the content database. Then, the archive file application 134 can invoke the automatic file explode process 530 on the existing archive file. This automatic file explode process 530 can comprise a metadata retention process 535.

In accordance with an embodiment, upon the accessing of the archive file 505, the archive file application 134 copy the archive file 505 at a temporary location on the server-side (not shown) and explode it. Then, the a check-in agent of the content management application 133 can automatically start a check-in process for each content item and data/files 510 within the archive file one-by-one, while maintaining the original structure (e.g., hierarchical structured) of the files based upon structure data 515 stored. The check-in agent can then store the exploded data/files 510 at the content database 136, and can store the associated structure data 515 at the metadata database.

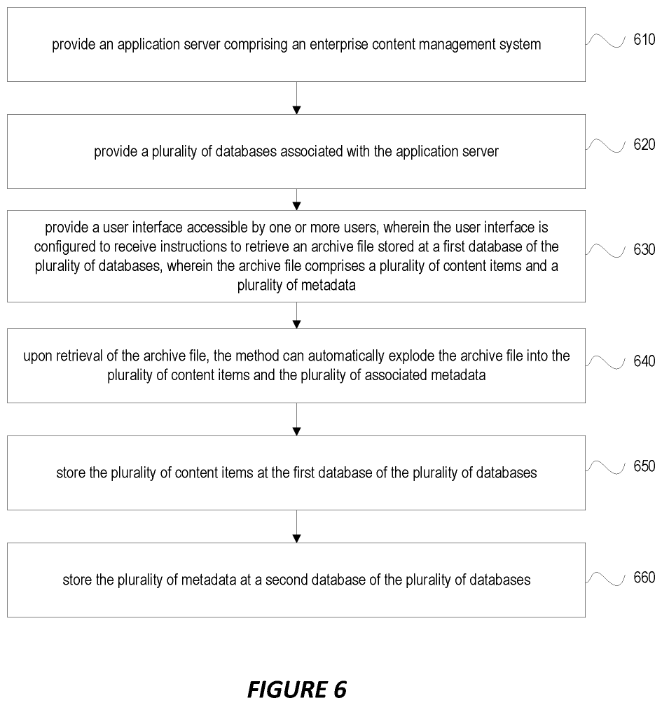

FIG. 6 is a flow chart of a method for performing automatic archive file explosion during an archive access operation at an ECM system.

At step 610, the method can provide an application server comprising an enterprise content management system.

At step 620, the method can provide a plurality of databases associated with the application server.

At step 630, the method can provide a user interface accessible by one or more users, wherein the user interface is configured to receive instructions to retrieve an archive file stored at a first database of the plurality of databases, wherein the archive file comprises a plurality of content items and a plurality of metadata.

At step 640, upon retrieval of the archive file, the method can automatically explode the archive file into the plurality of content items and the plurality of associated metadata.

At step 650, the method can store the plurality of content items at the first database of the plurality of databases.

At step 660, the method can store the plurality of metadata at a second database of the plurality of databases.

### Archive File Explosion During Check-Out in ECM

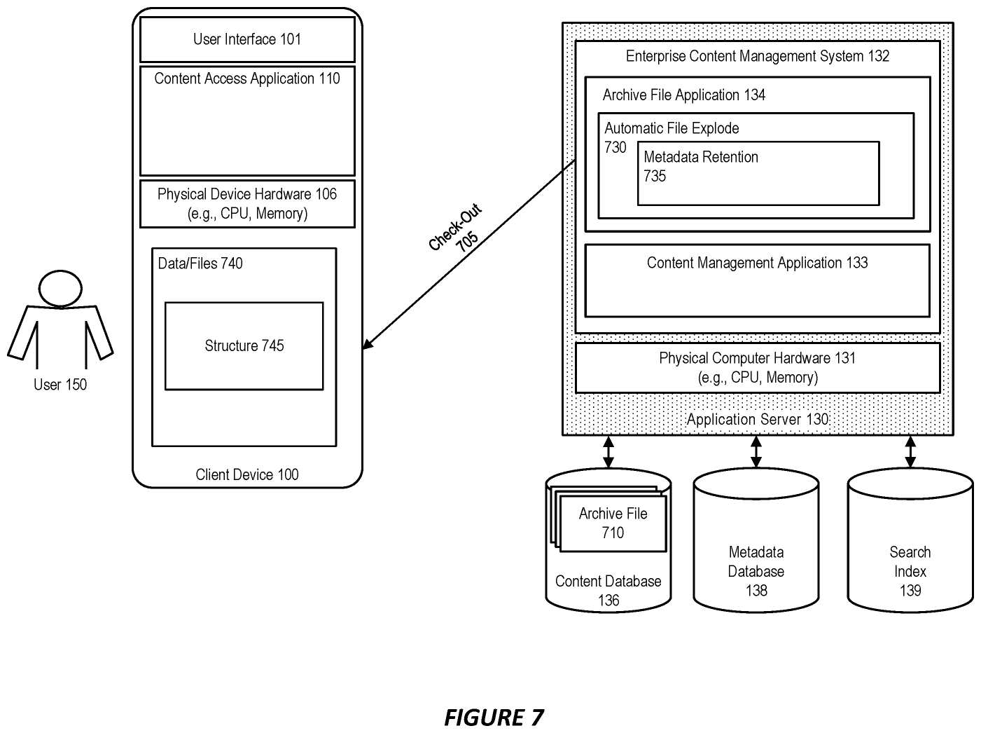

FIG. 7 shows an archive file (e.g., zip file) explosion during checkout of an ECM system, in accordance with an embodiment.

In accordance with an embodiment, in an enterprise content management system, when a user of an ECM application wants to download multiple files and/or also the contents of an entire folder, users need to download each content item one-by-one by performing multiple checkout operations which is a time consuming task. Additionally, in a legacy/pre-existing enterprise content management systems, there can exist large number of archive files that are already uploaded. When the contents within such archive files needs to be accessed, the users previously would have had to download and then explode the downloaded archive file on a local machine, which is again a time consuming task.

In accordance with an embodiment, therefore, the systems and methods can enable users of ECM systems to select and download multiple content items from the ECM system by performing single checkout operation onto a pre-selected destination directory on the client machine.

In accordance with an embodiment, similarly, an archive file can also be selected for download and auto-explode. When a user signals to download an archive file by performing checkout operation and flag it as explode checkout operation, the ECM system can copy the archive file at a temporary location on the server-side and explode it. Then, the checkout agent can push the contents of the exploded archive file one-by-one onto a selected destination directory on the client machine, while preserving the hierarchical structure.

In accordance with an embodiment, the systems and methods herein can provide a feature for users to select and download an archive file from an ECM system, and the archive file will be auto-exploded as if the file was exploded post download on the client machine manually which will again be saving time for end-users.

In accordance with an embodiment, the systems and methods provided herein enable users of ECM systems to automatically explode existing archive files in ECM systems so as to download/check-out the files individually while maintaining the files' hierarchical structure. When a user checks out 705 an existing archive file 710, the ECM system can first copy the existing archive file at a temporary location on the server-side and explode it. Then, the internal check-out agent can automatically, based upon the received flag, start a check-out process for each content item within the archive file, while maintaining the original structure (e.g., hierarchical structured) of the files, so as the push the files to the client device 100.

As illustrated in FIG. 7, in accordance with an embodiment, for a client device 100, having a user interface 101, and physical device hardware 106, (e.g., CPU, memory), the client device can be provided with a content access application 110 for execution thereon.

In accordance with an embodiment, the client device can be in communication with an application server 130 that includes a physical computer hardware 131 (e.g. CPU, memory) and an enterprise content management system 132, which can include a content management application 133 and an archive file application 134.

In accordance with an embodiment, the content access application at the client device can communicate with the enterprise content management system via a network. The content access application can be configured to enable a user 150 to view, upload, modify, delete, or otherwise access content such as data/files client device. For example, existing content, such as existing archive file 710, can be checked-out via the user interface by a user interacting with the content access application on an associated client device.

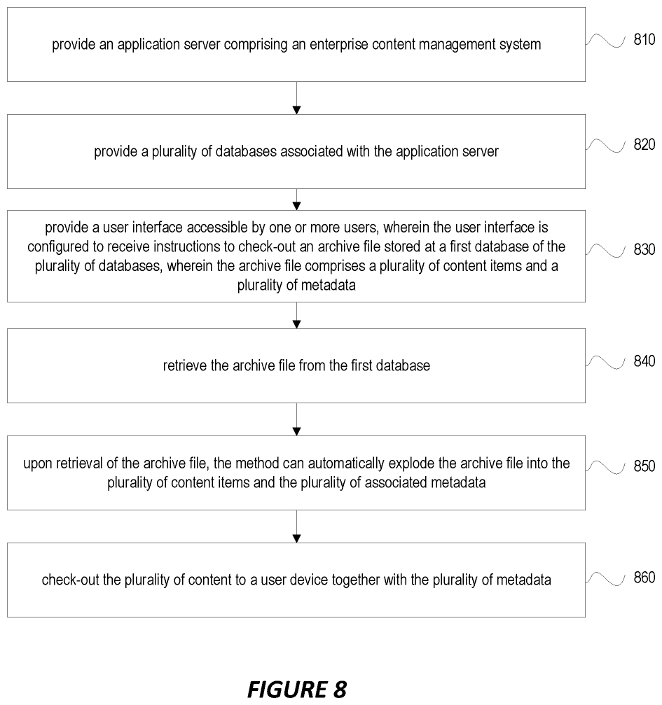

FIG. 8 is a flow chart of a method for performing automatic archive file explosion during a check-out operation at an ECM system.

At step 810, the method can provide an application server comprising an enterprise content management system.

At step 820, the method can provide a plurality of databases associated with the application server.

At step 830, the method can provide a user interface accessible by one or more users, wherein the user interface is configured to receive instructions to check-out an archive file stored at a first database of the plurality of databases, wherein the archive file comprises a plurality of content items and a plurality of metadata.

At step 840, the method can retrieve the archive file from the first database.

At step 850, upon retrieval of the archive file, the method can automatically explode the archive file into the plurality of content items and the plurality of associated metadata.

At step 860, the method can check-out the plurality of content to a user device together with the plurality of metadata.

In accordance with an embodiment, the enterprise content management system can be or can include a platform for consolidating content that can be managed by a plurality of users of an enterprise. In accordance with an embodiment, the enterprise content management system can be configured to communicate with a content database 136 for storing content (or content items), and can deliver the content to users via their client devices. In accordance with an embodiment, the content database can be a relational database management system (RDBMS), file system, or other data source which the enterprise content management system can access. Content can include, for example, documents, files, e-mails, memos, images, videos, slide presentations, conversations, and user profiles.

In accordance with an embodiment, the enterprise content management system can be configured to associate metadata with the content. Metadata can include information about an item of content, such as its title, author, release date, historical data such as who has accessed the item and when, a location where the content is stored, hierarchical structure of data, and the like.

In accordance with an embodiment, the metadata can be stored in a metadata database 138. In accordance with an embodiment, the enterprise content management system can be configured to communicate with the metadata database to access metadata stored therein, and to store metadata generated by the system in the metadata database.

In accordance with an embodiment, the enterprise content management system can also be configured to communicate with a search index 139. The search index can be configured to provide indexing and searching of content and data stored in the content database and the metadata database. In accordance with an embodiment, the search index can be a relational database management system (RDBMS) or a search tool such as Oracle Secure Enterprise Search (Oracle SES).

In accordance with an embodiment, the archive file application 134 can be provided at the ECM system 132 in order to allow users 150 to have existing archive files 710 be automatically exploded, via an automatic file explode process 730, upon a check-out operation 705.

In accordance with an embodiment, the archive file check-in/out module can be provided as an independent pluggable module for use with one or more existing content management systems, including the enterprise content management system 132.

In accordance with an embodiment, upon receiving a check-out archive file request 705, the archive file check-in/check-out module can access an existing archive file 710 at the content database. Then, the archive file application 134 can invoke the automatic file explode process 730 on the existing archive file. This automatic file explode process 730 can comprise a metadata retention process 735.

In accordance with an embodiment, upon the accessing of the archive file 710, the archive file application 134 copy the archive file 710 at a temporary location on the server-side (not shown) and explode it. Then, the a check-out agent of the content management application 133 can automatically start a check-out process for each content item (e.g., data files 740) within the archive file one-by-one, while maintaining the original structure 745 (e.g., hierarchical structure). The check-out agent can then check-out/transfer the exploded data/files 740 at the client device along with the associated structure 745.

While various embodiments of the present invention have been described above, it should be understood that they have been presented by way of example, and not limitation. The embodiments were chosen and described in order to explain the features and principles of the invention and its practical application. The embodiments illustrate systems and methods in which the various features of the present invention are utilized to improve the performance of the systems and methods by providing new and/or improved functions, and/or providing performance advantages including, but not limited to, reduced resource utilization, increased capacity, increased throughput, improved efficiency, reduced latency, enhanced security, and/or improved ease of use.

Some embodiments of the present invention are described herein with reference to flowcharts and/or block diagrams of methods, apparatus (systems), and computer program products which illustrate the architecture, functionality, process, and/or operation. Each block in the flowchart or block diagram represents an element, function, process, module, segment, or portion of instructions, which comprises one or more executable instructions for implementing the specified function. In some alternative embodiments, the functions noted in a block diagram or flowchart, occur out of the order noted in the figures. For example, two blocks shown in succession may be executed substantially concurrently, or in the reverse order, depending upon the functionality involved. Each block of the flowcharts and/or block diagrams, and combinations of blocks in the flowcharts and/or block diagrams, can be implemented by computer program instructions, and/or by special purpose hardware, and/or combinations of hardware and computer program instructions, which perform the specified functions.

In some embodiments, features of the present invention are implemented in a computer including a processor, a computer-readable storage medium, and a network card/interface for communicating with other computers. In some embodiments, features of the present invention are implemented in a network computing environment comprising a computing system including various types of computer configurations, including personal computers, hand-held devices, multi-processor systems, microprocessor-based or programmable consumer electronics, network PCs, minicomputers, mainframe computers, and the like interconnected by a network. The network can be a Local Area Network (LAN), switch fabric network (e.g. InfiniBand), Wide Area Network (WAN), and/or the Internet. The network can include copper transmission cables, optical transmission fibers, wireless transmission, routers, firewalls, switches, gateway computers and/or edge servers.

In some embodiments, features of the present invention are implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the subject matter described herein), or any combination of such back-end, middleware, or front-end components interconnected by a network. The computing system can include clients and servers having a client-server relationship to each other. In some embodiments, features of the invention are implemented in a computing system comprising a distributed computing environment in which one or more clusters of computers are connected by a network. The distributed computing environment can have all computers at a single location or have clusters of computers at different remote geographic locations connected by a network.

In some embodiments, features of the present invention are implemented in the cloud as part of, or as a service of, a cloud computing system based on shared, elastic resources delivered to users in a self-service, metered manner using Web technologies. Characteristics of the cloud may include, for example: on-demand self-service; broad network access; resource pooling; rapid elasticity; and measured service. Cloud deployment models include: Public, Private, and Hybrid. Cloud service models include Software as a Service (SaaS), Platform as a Service (PaaS), Database as a Service (DBaaS), and Infrastructure as a Service (IaaS). The cloud generally refers to the combination of hardware, software, network, and web technologies which delivers shared elastic resources to users. The cloud, as used herein, may include public cloud, private cloud, and/or hybrid cloud embodiments, and may include cloud SaaS, cloud DBaaS, cloud PaaS, and/or cloud IaaS deployment models.

In some embodiments, features of the present invention are implemented using, or with the assistance of hardware, software, firmware, or combinations thereof. In some embodiments, features of the present invention are implemented using a processor configured or programmed to execute one or more functions of the present invention. The processor is in some embodiments a single or multi-chip processor, a digital signal processor (DSP), a system on a chip (SOC), an application specific integrated circuit (ASIC), a field programmable gate array (FPGA) or other programmable logic device, state machine, discrete gate or transistor logic, discrete hardware components, or any combination thereof designed to perform the functions described herein. In some implementations, features of the present invention are implemented by circuitry that is specific to a given function. In other implementations, features are implemented in a computer, computing system, processor, and/or network, configured to perform particular functions using instructions stored e.g. on a computer-readable storage media.

In some embodiments, features of the present invention are incorporated in software and/or firmware for controlling the hardware of a processing and/or networking system, and for enabling a processor and/or network to interact with other systems utilizing the features of the present invention. Such software or firmware may include, but is not limited to, application program code, device drivers, operating systems, virtual machines, hypervisors, application programming interfaces, programming languages, and execution environments/containers. Appropriate software coding can readily be prepared by skilled programmers based on the teachings of the present disclosure.

In some embodiments, the present invention includes a computer program product which is a machine-readable or computer-readable storage medium (media) having instructions comprising software and/or firmware stored thereon/in, which instructions can be used to program or otherwise configure a system such as a computer to perform any of the processes or functions of the present invention. The storage medium or computer readable medium can include any type of media or device suitable for storing instructions and/or data including, but not limited to, floppy disks, hard drives, solid state drives, optical discs, DVD, CD-ROMs, microdrives, and magneto-optical disks, ROMs, RAMs, EPROMs, EEPROMs, DRAMs, VRAMs, flash memory devices, magnetic or optical cards, molecular memories, nanosystems, or variations and combinations thereof. In particular embodiments, the storage medium or computer readable medium is a non-transitory machine-readable storage medium or non-transitory computer-readable storage medium.

The foregoing description is not intended to be exhaustive or to limit the invention to the precise forms disclosed. Additionally, where embodiments of the present invention have been described using a particular series of transactions and steps, it should be apparent to those skilled in the art that, unless stated, the embodiment does not exclude performance of additional transactions and steps. Further, while the various embodiments describe particular combinations of features of the invention it should be understood that different combinations of the features will be apparent to persons skilled in the relevant art as within the scope of the invention. In particular, a feature (device-like or method-like) recited in a given embodiment, variant, or shown in a drawing may be combined with or replace another feature in another embodiment, variant or drawing, without departing from the scope of the present invention. Moreover, it will be apparent to persons skilled in the relevant art that various additions, subtractions, deletions, variations, substitutions of elements with equivalents, and other modifications and changes in form, detail, implementation and application can be made therein without departing from the spirit and scope of the invention. It is intended that the broader spirit and scope of the invention be defined by the following claims and their equivalents.

What is claimed is:

1. A system for archive file check-in/out in an enterprise content management system, comprising:
an application server comprising an enterprise content management system;
a plurality of databases associated with the application server;
a user interface accessible by one or more users, wherein the user interface is configured to receive instructions relating to an archive file, wherein the file comprises a plurality of content items and a metadata;
wherein the enterprise content management system comprises a check-in/check-out component; and
wherein the enterprise content management system further comprises an archive file application.

2. The system of claim 1, wherein the received instruction comprises an instruction to check in the archive file, wherein the archive file is uploaded from a client device;
wherein upon upload of the archive file from the client device, the archive file is automatically exploded into the plurality of content items and the metadata;
wherein the check-in/check-out component stores the plurality of exploded content items at a first database of the plurality of databases; and
wherein the check-in/check-out component stores the exploded metadata at a second database of the plurality of databases.

3. The system of claim 2, wherein the metadata comprises hierarchical structure information of the plurality of content items.

4. The system of claim 1, wherein the received instruction comprises an instruction to access the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component stores the exploded plurality of content items at the first database of the plurality of databases; and
wherein the check-in/check-out component stores the exploded metadata at a second database of the plurality of databases.

5. The system of claim 4, wherein the metadata comprises hierarchical structure information of the plurality of content items.

6. The system of claim 1, wherein the received instruction comprises an instruction to check-out the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component checks the exploded plurality of content items to a client device; and
wherein the check-in/check-out component checks-out the exploded metadata to the client device.

7. The system of claim 6, wherein the metadata comprises hierarchical structure information of the plurality of content items.

8. A method for archive file check-in/out in an enterprise content management system, comprising:
providing an application server comprising an enterprise content management system;
providing a plurality of databases associated with the application server;
providing a user interface accessible by one or more users, wherein the user interface is configured to receive instructions relating to an archive file, wherein the file comprises a plurality of content items and a metadata;
wherein the enterprise content management system comprises a check-in/check-out component; and
wherein the enterprise content management system further comprises an archive file application.

9. The method of claim 8, wherein the received instruction comprises an instruction to check in the archive file, wherein the archive file is uploaded from a client device;
wherein upon upload of the archive file from the client device, the archive file is automatically exploded into the plurality of content items and the metadata;
wherein the check-in/check-out component stores the plurality of exploded content items at a first database of the plurality of databases; and
wherein the check-in/check-out component stores the exploded metadata at a second database of the plurality of databases.

10. The method of claim 9, wherein the metadata comprises hierarchical structure information of the plurality of content items.

11. The method of claim 8, wherein the received instruction comprises an instruction to access the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component stores the exploded plurality of content items at the first database of the plurality of databases; and
wherein the check-in/check-out component stores the exploded metadata at a second database of the plurality of databases.

12. The method of claim 11, wherein the metadata comprises hierarchical structure information of the plurality of content items.

13. The method of claim 8, wherein the received instruction comprises an instruction to check-out the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component checks the exploded plurality of content items to a client device; and
wherein the check-in/check-out component checks-out the exploded metadata to the client device.

14. The method of claim 13, wherein the metadata comprises hierarchical structure information of the plurality of content items.

15. A non-transitory computer readable storage medium having instructions thereon for archive file check-in/out in an enterprise content management system, comprising:
providing an application server comprising an enterprise content management system;
providing a plurality of databases associated with the application server;
providing a user interface accessible by one or more users, wherein the user interface is configured to receive instructions relating to an archive file, wherein the file comprises a plurality of content items and a metadata;
wherein the enterprise content management system comprises a check-in/check-out component; and
wherein the enterprise content management system further comprises an archive file application.

16. The non-transitory computer readable storage medium of claim 15, wherein the received instruction comprises an instruction to check in the archive file, wherein the archive file is uploaded from a client device;
wherein upon upload of the archive file from the client device, the archive file is automatically exploded into the plurality of content items and the metadata;
wherein the check-in/check-out component stores the plurality of exploded content items at a first database of the plurality of databases; and
wherein the check-in/check-out component stores the exploded metadata at a second database of the plurality of databases.

17. The non-transitory computer readable storage medium of claim 16, wherein the metadata comprises hierarchical structure information of the plurality of content items.

18. The non-transitory computer readable storage medium of claim 15, wherein the received instruction comprises an instruction to access the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component stores the exploded plurality of content items at the first database of the plurality of databases; and
wherein the check-in/check-out component stores the exploded metadata at a second database of the plurality of databases.

19. The non-transitory computer readable storage medium of claim 18, wherein the metadata comprises hierarchical structure information of the plurality of content items.

20. The non-transitory computer readable storage medium of claim 15, wherein the received instruction comprises an instruction to check-out the archive file, wherein the archive file is retrieved from a first database of the plurality of databases;
wherein upon retrieval of the archive file from a first database of the plurality of databases, the archive file is automatically exploded into the plurality of content items and the metadata;
wherein the check-in/check-out component checks the exploded plurality of content items to a client device;
wherein the check-in/check-out component checks-out the exploded metadata to the client device; and
wherein the metadata comprises hierarchical structure information of the plurality of content items.
